(19) United States
(12) Patent Application Publication
(10) Pub. No.: US 2021/0122410 A1
(43) Pub. Date: Apr. 29, 2021

(54) Steering head bearing arrangement

(71) Applicant: Schaeffler Technologies AG & Co. KG, Herzogenaurach (DE)

(72) Inventors: Andreas Wöllner, Nürnberg (DE); Benjamin Wuebbolt-Gorbatenko, Erlangen (DE); Simon Mersmann, Herzogenaurach (DE); Christian Harkort, Erlangen (DE); Manfred Kraus, Herzogenaurach (DE)

(73) Assignee: Schaeffler Technologies AG & Co. KG, Herzogenaurach (DE)

(21) Appl. No.: 17/042,644

(22) PCT Filed: Mar. 11, 2019
(86) PCT No.: PCT/DE2019/100212

§ 371 Date: Sep. 28, 2020

(30) Foreign Application Priority Data
Apr. 4, 2018 (DE) 10 2018 107 890.0

(51) Int. Cl. B62D 5/04

(52) U.S. Cl. CPC B62D 5/0418; B62D 5/0481; B62D 5/0403

(57) ABSTRACT

A steering head bearing arrangement for mounting a wheel module for a motor vehicle is provided with a steering rod connectable to a steering actuator and a wishbone, and a bearing flange connectable with a support frame of the motor vehicle, first and second roller bearings arranged in the bearing flange for mounting the steering rod, and a retaining ring screwed onto the steering rod for biasing the second roller bearing against the first roller bearing. By biasing the substantially spaced apart roller bearings against each other by means of the screwed-on retaining ring, radial and axial play of the steering rod in the bearing flange can be largely eliminated, thereby allowing to avoid wear-intensive peak stresses and allowing robust mounting of a steering rod of a motor vehicle.

### CROSS-REFERENCE TO RELATED APPLICATIONS

This application is the U.S. National Phase of PCT Appln. No. PCT/DE2019/100212 filed Mar. 11, 2019, which claims priority to DE 10 2018 107 890.0 filed Apr. 4, 2018, the entire disclosures of which are incorporated by reference herein.

### TECHNICAL FIELD

The disclosure relates to a steering head bearing arrangement by means of which a steering rod of a wheel module for a motor vehicle can be rotatably mounted in the motor vehicle.

### BACKGROUND

A motor vehicle with a wheel module is known from CN 206679065 U, in which a wheel of the wheel module can be rotated by 90° about a vertical steering axle in order to be able to park the motor vehicle even in narrow parking spaces.

### SUMMARY

There is a constant need for robust mounting of a steering rod of a motor vehicle.

It is desirable to demonstrate measures which enable robust mounting of a steering rod of a motor vehicle.

Robust mounting of a steering rod is achieved by a steering head bearing arrangement.

A steering head bearing arrangement for mounting a wheel module for a motor vehicle is provided with a steering rod connectable to a steering actuator and a wishbone, and a bearing flange, directly or indirectly connectable with a support frame of the motor vehicle for the passage of the steering rod, a first roller bearing arranged in the bearing flange for mounting the steering rod in the bearing flange, a second roller bearing arranged in the bearing flange for mounting the steering rod in the bearing flange, and a retaining ring screwed onto the steering rod for biasing the second roller bearing against the first roller bearing.

By means of the retaining ring screwed onto the steering rod, the second roller bearing can be pressed towards the first roller bearing, whereby the roller bearings form contact mounting in which the roller bearings are biased against one another without axial play. For this purpose, the first roller bearing can be supported, for example, radially on the outside on a shoulder of the bearing flange with an outer ring, while an inner ring of the first roller bearing can be supported on a shoulder of the steering rod inserted into the bearing flange. An outer ring of the second roller bearing can be supported radially on the outside on a shoulder spaced apart far enough from the first roller bearing in the axial direction. The retaining ring, which is screwed on, in particular in the manner of a shaft nut, can abut against an inner ring of the second roller bearing after a certain screw length and entrain the inner ring of the second roller bearing when it is screwed on further. An axial play between the roller bearings can thereby be eliminated. In this case, the steering rod can be pulled from the retaining ring in the direction of the bearing flange, in particular also against gravity, as a result of which the first roller bearing can be clamped between the steering rod and the bearing flange without play. The bearing flange is particularly preferably designed to be fastened to the support frame, in particular a longitudinal member and/or a cross member of the support frame. As a result, the bearing flange can easily have an axial extent corresponding to the thickness of the support frame or exceeding the thick-ness of the support frame, in particular in the vertical direction. This axial extension of the bearing flange enables a comparatively large axial distance between the roller bearings. The large axial distance between the roller bearings minimizes tilting of the steering rod in the bearing flange, for example due to radial play. For this purpose, the roller bearings are designed in particular as angular contact ball bearings, tapered roller bearings, or conical needle bearings. By biasing the substantially spaced apart roller bearings against each other by means of the screwed-on retaining ring, radial and axial play of the steering rod in the bearing flange can be largely eliminated, thereby allowing to avoid wear-intensive peak stresses and allowing robust mounting of a steering rod of a motor vehicle.

In particular, a rotation angle sensor for detecting a rotation angle of the steering rod is arranged on a rear of the retaining ring facing away from the roller bearings. After the screwed-on retaining ring has eliminated axial play in the roller bearings, there remains a shaft end of the steering rod that protrudes from the retaining ring. Here, the axial extension of the shaft end of the steering rod is chosen long enough to enable the retaining ring to be screwed on and preferably to be able to bring about a connection, in particular a positive connection, with a steering actuator. This free axial distance of the shaft end of the steering rod can be used for the provision of the angle sensor. The rotation angle sensor in this case can be provided in an axial region of the steering rod, which is present anyway and in which sufficient installation space in the radial direction is reserved for the rotation angle sensor. As a result, the rotation angle sensor can be installed essentially without requiring any additional installation space. The rotation angle sensor can in particular optically detect an angle of rotation position of the rotatable steering rod relative to the fixed bearing flange. The angle assumed by the wheel of the wheel module relative to a straight-ahead position substantially corresponds to the angular position of the steering rod and/or can be determined from the angular position of the steering rod. This makes it easy to control a desired steering position of the wheel via the steering rod.

The rotation angle sensor preferably has a scanning direction aligned in the axial direction of the steering rod. As a result, the rotation angle sensor does not need to be aligned in the radial direction in order to optically scan an outer surface of the steering rod. Scanning errors of the rotation angle sensor by an external thread formed on the outer surface of the steering rod for the retaining ring can thereby be avoided. Instead, the rotation angle sensor can scan a component that protrudes radially from the steering rod.

The rotation angle sensor is particularly preferably connected to the bearing flange, wherein the rotation angle sensor optically scans the rear of the retaining ring. This exploits the knowledge that the retaining ring is screwed onto the steering rod in a rotationally fixed manner after the roller bearings are biased so that the angular position of the retaining ring relative to the bearing flange corresponds to the angular position of the steering rod relative to the bearing flange. In addition, the back of the retaining ring is not required for biasing the roller bearings so that it is easily possible to attach optical markings on the rear of the retaining ring, which can be recognized by the scanning direction of the rotation angle sensor. As a result, the retaining ring can also perform a function in measuring the angle of rotation. A separate sensor disk can be eliminated, saving manufacturing costs and installation space.

In particular, a mounting flange for the centering reception of a steering actuator connectable to the steering rod is connected to the bearing flange, wherein the mounting flange at least partially covers the rotation angle sensor and/or the sensor receiving ring receiving the rotation angle sensor axially and/or radially. The mounting flange can be fastened to the bearing flange, for example by screwing. For this purpose, a certain minimum thickness is required for the bearing flange and the mounting flange at the fastening point in order to enable stable and robust fastening. The bearing flange already has a sufficient axial extent to accommodate the roller bearings at a sufficient distance from one another. The mounting flange in the area of the fastening point with the bearing flange can have a thickness in the axial direction that is greater than would be required for centering the steering actuator. This axial extension of the mounting flange can be used to at least partially cover the rotation angle sensor in the manner of a cover. As a result, the axial extension of the bearing flange in the region of the retaining ring and the rotation angle sensor, which protrudes beyond the roller bearings, can be made correspondingly shorter, as a result of which axial installation space can be saved. The rotation angle sensor or the sensor receiving ring receiving the rotation angle sensor is thus protected from environmental influences in a space-saving manner, not only by the bearing flange but also by the mounting flange.

A cleaning element is preferably provided for mechanically cleaning the rotation angle sensor and/or the retaining ring. When the steering rod rotates relative to the bearing flange, the cleaning element connected to the rotation angle sensor or to the sensor mounting ring or the bearing flange can perform a relative movement to the retaining ring. The cleaning element, which is designed, for example, as a brush, in this case can be guided over optical markings on the rear of the retaining ring, as a result of which contaminants which could impair the optical scanning by the rotation angle sensor can be removed. Accordingly, it is possible that the cleaning element, for example designed in the form of a brush, is fastened to the retaining ring and can remove contamination on the rotation angle sensor, in particular on a photo element, when performing a relative rotation. This enables high accuracy in the measurement of the angle of rotation over a long operating period.

A steering actuator for introducing a steering movement into the steering rod is particularly preferably provided substantially coaxially with the steering rod, wherein the steering actuator is positively coupled with the steering rod, in particular via a Hirth toothing. A drive shaft of the steering actuator can be connected to the steering rod easily and in an installation space-saving manner. Radially protruding flanges of the drive shaft and the steering rod can be avoided so that the space otherwise required for the flanges can be saved.

In particular, the steering rod, with the bearing flange on a lower axial side of the bearing flange in the direction of gravity, in particular wherein the labyrinth seal has an annular web inserted in an annular groove. Contamination that has fallen due to gravity, such as abrasion, can easily be retained by the labyrinth seal. An elastomeric seal can be eliminated.

Preferably the steering rod is oriented substantially vertically, in particular wherein a steering head angle α of a steering axis of the steering rod to a horizontal base is 70°≤α≤95°, in particular 75°≤α≤93°, preferably 80°≤α≤90°, and particularly preferably 85°≤α≤88°. Due to the particularly steep alignment of the steering axle, particularly large steering angles can be easily achieved. This enables the driving of particularly tight curves. It is even easily achievable to drive with the motor vehicle not only essentially in longitudinal direction, but even in transverse direction. This makes it possible to park in a particularly narrow parking space without a maneuvering distance in the longitudinal direction.

A wheel module for a motor vehicle, in particular multi-track passenger cars, has a wheel for locomotion of the motor vehicle, a steering head bearing arrangement, which can be designed and developed as described above, for mounting the steering rod on a support frame of the motor vehicle, a wish-bone connected to the steering rod to form an articulation point offset radially with respect to the wheel, a rocker pivotally connected to the articulation point of the wish-bone and to the wheel, and a shock absorber connected to the rocker and wishbone to dampen vibrations of a relative movement of the wheel. By biasing the substantially spaced apart roller bearings of the steering head bearing arrangement against each other by means of the screwed-on retaining ring, radial and axial play of the steering rod in the bearing flange can be largely eliminated, thereby allowing to avoid wear-intensive peak stresses and allowing robust mounting of a steering rod of a motor vehicle.

### BRIEF DESCRIPTION OF THE DRAWINGS

In the following, the steering head and wheel module are explained by way of example with reference to the attached drawings using preferred exemplary embodiments. In the figures:

FIG. 1: shows a schematic diagram of a wheel module,

FIG. 2: shows a schematic perspective view of an embodiment of the wheel module of FIG. 1, and

FIG. 3: shows a schematic cutaway view of a steering head bearing arrangement of the wheel module of FIG. 2.

### DETAILED DESCRIPTION

The wheel module 10 shown in FIG. 1 for a motor vehicle designed as a multi-track passenger car has a steering rod 14 which can be rotated by a steering actuator 12. The steering rod 14 can be directly or indirectly rotatably mounted on a support frame 18 of the motor vehicle via a steering head bearing arrangement 16, in particular, wherein the steering rod 14 is mounted immovably in the axial direction of the steering rod 14, for example by an axial bearing. A wishbone 20 is attached to the steering rod 14 and forms an articulation point 24 on the horizontal level of an axis of rotation 38 of a wheel 22 of the wheel module 10 to be steered. At the articulation point 24 a rocker 26 is connected to the wheel 22 in a pivoted manner, whereby the rocker 26 is connected at the other end thereof in an articulated and coaxial manner to the wheel 22. A shock absorber 28 is attached to the wheel 22 and/or to the rocker 26, which is attached at the other end thereof to the steering rod 14 and/or to the wishbone 20. In the exemplary embodiment shown, a level control device 30 is provided between the shock absorber 28 and the steering rod 14. The wheel 22 can in particular be driven and/or decelerated by a wheel hub drive 32.

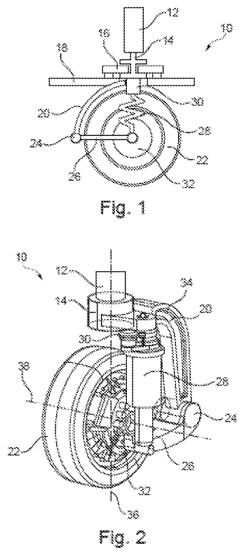

As depicted in FIG. 2, a fastening lug 34 can protrude radially from the steering rod 14, which is designed as a hollow shaft, to which the shock absorber 28 and optionally also the wishbone 20 is attached. This makes it possible to arrange the shock absorber 28 and/or the wishbone 20 axially next to the wheel 22. A steering axis 36, which in particular is essentially vertical, runs completely in front of the axis of rotation 38 of the wheel 22, so that even with different diameters of the wheel 22, the steering axle 36 runs as a secant through the wheel 22 in front of the axis of rotation 38. This ensures a positive caster for the wheel 22. When the steering actuator 12 rotates the wheel 22, the shock absorber 28, arranged next to the wheel 22 in an installation space-saving manner, can be entrained so that a steering angle of the steering rod 14 is not limited by the shock absorber 28. In principle, the wheel 22 can therefore perform any number of revolutions.

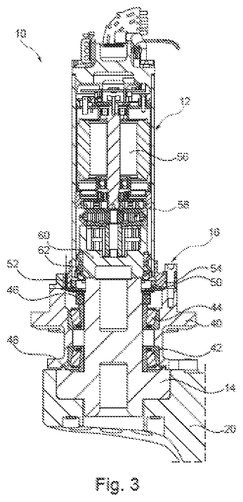

The steering head bearing arrangement 16 depicted in detail in FIG. 3 has a bearing flange 40 fastened to the support frame 18, in which the steering rod 14 is rotatably mounted. For this purpose, a lower first roller bearing 42 and an upper second roller bearing 44 are provided, which are each pressed into the bearing flange 40. On the shaft end of the steering rod 14 facing the steering actuator 12, a retaining ring 46 is screwed on, which presses the second roller bearing 44 onto the first roller bearing 42 and thereby biases the roller bearings 42, 44 against one another without play. Here, at the lower end of the bearing flange 40, a shoulder of the steering rod 14 is pulled onto the bearing flange 40 against gravity so that the first roller bearing 42 can be clamped between the steering rod 14 and the bearing flange 40 without play and the bearing flange 40 and the relatively rotatable steering rod 14 can form a labyrinth seal 48. On a rear of the retaining ring 46 facing away from the roller bearings 42, 44, a rotational angle sensor 52, which is received by a sensor receiving ring 50, is provided at a slight distance in the axial direction from the retaining ring 46. The rotation angle sensor can be aligned in the axial direction and can scan optical markings on the rear of the retaining ring 46, for example by means of a photo element. A mounting flange 54 is screwed to the upper end of the bearing flange 40, by means of which the steering actuator 12 can be centered and/or fastened. The mounting flange 54 can at least partially cover the sensor mounting ring 50 and the rotation angle sensor 52 in the manner of a cover. The steering actuator 12 has an electric motor 56, which can drive an output shaft 60 via a gear stage 58, which in turn is positively coupled to the steering rod 14 via a Hirth toothing 62 to be able to turn the wheel 22 of the wheel module 10 by a steering angle monitored by the rotation angle sensor 30.

### LIST OF REFERENCE SYMBOLS

10 wheel module
12 steering actuator
14 steering rod
16 steering head bearing arrangement
18 support frame
20 wishbone
22 wheel
24 articulation point
26 rocker
28 shock absorber
30 level control device
32 wheel hub drive
34 fastening lug
36 steering axle
38 axis of rotation
40 bearing flange
42 first roller bearing
44 second roller bearing
46 retaining ring
48 labyrinth seal
50 sensor receiving ring
52 rotation angle sensor
54 mounting flange
56 electrical motor
58 gear stage
60 output shaft
62 Hirth toothing

1. A steering head bearing arrangement for mounting a wheel module for a motor vehicle, the steering head comprising:
a steering rod connectable to a steering actuator and a wishbone,
a bearing flange connectable directly or indirectly to a support frame of the motor vehicle,
a first roller bearing arranged in the bearing flange for mounting the steering rod in the bearing flange,
a second roller bearing arranged in the bearing flange for mounting the steering rod in the bearing flange, and
a retaining ring screwed onto the steering rod for biasing the second roller bearing against the first roller bearing.

2. The steering head bearing arrangement according to claim 1, wherein a rotation angle sensor for detecting a rotation angle of the steering rod is arranged on a rear of the retaining ring facing away from the roller bearings.

3. The steering head bearing arrangement according to claim 2, wherein the rotation angle sensor has a scanning direction aligned in an axial direction of the steering rod.

4. The steering head bearing arrangement according to claim 2, wherein the rotation angle sensor is connected to the bearing flange, wherein the rotation angle sensor optically scans the rear of the retaining ring.

5. The steering head bearing arrangement according to claim 2, wherein a mounting flange for centering reception of a steering actuator connectable to the steering rod is connected to the bearing flange, wherein the mounting flange at least partially covers the rotation angle sensor and/or the sensor receiving ring receiving the rotation angle sensor axially and/or radially.

6. The steering head bearing arrangement according to claim 1, wherein a cleaning element for mechanical cleaning of the retaining ring is provided.

7. The steering head bearing arrangement according to claim 1, wherein a steering actuator for introducing a steering movement into the steering rod is provided substantially coaxially with the steering rod, wherein the steering actuator is positively coupled with the steering rod, in particular via a Hirth toothing.

8. The steering head bearing arrangement according to claim 1 wherein the steering rod, with the bearing flange, forms a labyrinth seal on a lower axial side of the bearing flange in a direction of gravity, in particular wherein the labyrinth seal has an annular web inserted in an annular groove.

9. The steering head bearing arrangement according to claim 1 wherein the steering rod is oriented substantially vertically, in particular wherein a steering head angle α of a steering axle of the steering rod to a horizontal base is 70°≤α≤95°.

10. A wheel module for a motor vehicle having
a wheel for moving the motor vehicle,
a steering head bearing arrangement according to claim 1 for mounting the steering rod on a support frame of the motor vehicle,
a wishbone connected to the steering rod to form an articulation point radially offset from the wheel,
a rocker articulated to the articulation point of the wishbone and to the wheel and
a shock absorber connected to the rocker and the wishbone for damping vibrations of a relative movement of the wheel.

11. A steering head bearing arrangement for mounting a wheel module for a motor vehicle, the steering head comprising:
a steering rod connectable to a steering actuator and a wishbone;
a bearing flange connectable directly or indirectly to a support frame of the motor vehicle;
a first roller bearing arranged in the bearing flange for mounting the steering rod in the bearing flange;
a second roller bearing arranged in the bearing flange for mounting the steering rod in the bearing flange;
a retaining ring screwed onto the steering rod for biasing the second roller bearing against the first roller bearing; and
a rotation angle sensor for detecting a rotation angle of the steering rod arranged on a rear of the retaining ring facing away from the roller bearings.

12. The steering head bearing arrangement according to claim 11, wherein a cleaning element for mechanical cleaning of the rotation angle sensor and/or the retaining ring is provided.

13. The steering head bearing arrangement according to claim 11, wherein a steering actuator for introducing a steering movement into the steering rod is provided substantially coaxially with the steering rod, wherein the steering actuator is positively coupled with the steering rod, in particular via a Hirth toothing.

14. The steering head bearing arrangement according to claim 11 wherein the steering rod, with the bearing flange, forms a labyrinth seal on a lower axial side of the bearing flange in a direction of gravity, in particular wherein the labyrinth seal has an annular web inserted in an annular groove.

15. The steering head bearing arrangement according to claim 11 wherein the steering rod is oriented substantially vertically, in particular wherein a steering head angle α of a steering axle of the steering rod to a horizontal base is 70°≤α≤95°.

16. A wheel module for a motor vehicle having
a wheel for moving the motor vehicle;
a steering head bearing arrangement according to claim 11 for mounting the steering rod on a support frame of the motor vehicle;
a wishbone connected to the steering rod to form an articulation point radially offset from the wheel;
a rocker articulated to the articulation point of the wishbone and to the wheel; and
a shock absorber connected to the rocker and the wishbone for damping vibrations of a relative movement of the wheel.

17. A steering head bearing arrangement for mounting a wheel module for a motor vehicle, the steering head comprising:
a steering rod connectable to a steering actuator and a wishbone;
a bearing flange connectable directly or indirectly to a support frame of the motor vehicle;
a first roller bearing arranged in the bearing flange for mounting the steering rod in the bearing flange;
a second roller bearing arranged in the bearing flange for mounting the steering rod in the bearing flange;
a retaining ring screwed onto the steering rod for biasing the second roller bearing against the first roller bearing; and
a cleaning element for mechanical cleaning of the retaining ring is provided.

18. The steering head bearing arrangement according to claim 17, wherein a steering actuator for introducing a steering movement into the steering rod is provided substantially coaxially with the steering rod, wherein the steering actuator is positively coupled with the steering rod, in particular via a Hirth toothing.

19. The steering head bearing arrangement according to claim 17 wherein the steering rod, with the bearing flange, forms a labyrinth seal on a lower axial side of the bearing flange in a direction of gravity, in particular wherein the labyrinth seal has an annular web inserted in an annular groove.

20. The steering head bearing arrangement according to claim 17 wherein the steering rod is oriented substantially vertically, in particular wherein a steering head angle α of a steering axle of the steering rod to a horizontal base is 70°≤α≤95°.
